(19) United States
(12) Patent Application Publication
(10) Pub. No.: US 2026/0115653 A1
(43) Pub. Date: Apr. 30, 2026

(54) HYBRID MEMBRANE PRESSURE SWING ADSORPTION PROCESS FOR SEPARATION OF CRACKED GASES FROM A METHANE PYROLYSIS REACTION

(71) Applicant: Chevron U.S.A. Inc., San Ramon, CA (US)

(72) Inventors: Daniel Chinn, Danville, CA (US); Steven Brogden, Carmel Valley, CA (US); Minhaal Hussein Kalyan, Torrance, CA (US)

(21) Appl. No.: 19/324,772

(22) Filed: Sep. 10, 2025

Related U.S. Application Data
(60) Provisional application No. 63/711,800, filed on Oct. 25, 2024.

(51) Int. Cl. B01D 53/22; B01D 53/047; B01D 71/56; B01D 71/64; C01B 3/26

(52) U.S. Cl. CPC B01D 53/229; B01D 53/047; B01D 53/228; B01D 71/56; B01D 71/64; C01B 3/26; B01D 2256/16; B01D 2257/702; C01B 2203/0277; C01B 2203/0425; C01B 2203/048; C01B 2203/1241; C01P 2006/80

(57) ABSTRACT

A process for producing high-purity hydrogen includes compressing a hydrogen-containing hydrocarbon gas stream derived from catalytically cracking a light hydrocarbon feedstock in the presence of a catalyst in a reactor, thereby producing a compressed hydrogen-containing hydrocarbon gas stream, passing the compressed hydrogen-containing hydrocarbon gas stream through a gas separation membrane, thereby producing a hydrogen-lean hydrocarbon retentate gas stream and a hydrogen-rich permeate gas stream, compressing the hydrogen-rich permeate stream to provide a compressed hydrogen-rich permeate gas stream, and introducing the compressed hydrogen-rich permeate gas stream into a pressure swing adsorption unit, thereby producing a high-purity hydrogen stream and a pressure swing adsorption tail gas stream.

### PRIORITY CLAIM

The present application claims priority to U.S. Provisional Patent Application Ser. No. 63/711,800, entitled “Hybrid Membrane Pressure Swing Adsorption Process for Separation of Cracked Gases from a Methane Pyrolysis Reaction,” filed Oct. 25, 2024, the content of which is incorporated by reference herein in its entirety.

### BACKGROUND

Natural gas may be thermally cracked at high temperatures (>900° C.) and low pressures using a catalyst to form cracked gas, such as hydrogen, ethylene, C₃ to C₅ olefins, aromatics, and polynuclear aromatics. Due to the formation of carbon on the catalyst, it is often desirable to conduct the reaction in a fluidized bed reactor with a continuous catalyst regeneration process where spent catalyst is withdrawn from the fluidized bed reactor and sent to a separate regeneration reactor where air is used to combust the carbon. The regenerated catalyst is fed back to the fluidized bed reactor, while the hot flue gases from the regeneration reactor may be sent to a selective catalyst reduction (SCR) unit prior to waste heat recovery/steam generation. The cracked gases leaving the fluidized bed reactor will need to undergo significant heat recovery and product separation.

### SUMMARY

In accordance with an illustrative embodiment, a process for producing high-purity hydrogen comprises:
compressing a hydrogen-containing hydrocarbon gas stream derived from catalytically cracking a light hydrocarbon feedstock in the presence of a catalyst in a reactor, thereby providing a compressed hydrogen-containing hydrocarbon gas stream,
passing the compressed hydrogen-containing hydrocarbon gas stream through a gas separation membrane, thereby producing a hydrogen-lean hydrocarbon retentate gas stream and a hydrogen-rich permeate gas stream,
compressing the hydrogen-rich permeate stream, thereby providing a compressed hydrogen-rich permeate gas stream, and
introducing the compressed hydrogen-rich permeate gas stream into a pressure swing adsorption unit, thereby producing a high-purity hydrogen stream and a pressure swing adsorption tail gas stream.

In accordance with an illustrative embodiment, a process for producing high-purity hydrogen comprises:
passing a compressed hydrogen-containing hydrocarbon gas stream having a first pressure through a gas separation membrane, thereby producing a hydrogen-lean hydrocarbon retentate gas stream and a hydrogen-rich permeate gas stream having a second pressure less than the first pressure,
compressing the hydrogen-rich permeate stream, thereby providing a compressed hydrogen-rich permeate gas stream having a third pressure greater than the second pressure, and
introducing the compressed hydrogen-rich permeate gas stream into a pressure swing adsorption unit, thereby producing a high-purity hydrogen stream and a pressure swing adsorption tail gas stream.

In accordance with another illustrative embodiment, a system comprises:
a first compressor configured to compress a hydrogen-containing hydrocarbon gas stream derived from catalytically cracking a light hydrocarbon feedstock in the presence of a catalyst in a reactor, thereby producing a compressed hydrogen-containing hydrocarbon gas stream,
a gas separation membrane configured to separate the compressed hydrogen-containing hydrocarbon gas stream, thereby producing a hydrogen-lean hydrocarbon retentate gas stream and a hydrogen-rich permeate gas stream,
a second compressor configured to compress the hydrogen-rich permeate stream, thereby producing a compressed hydrogen-rich permeate gas stream, and
a pressure swing adsorption unit configured to separate the compressed hydrogen-rich permeate gas stream into, thereby producing a high-purity hydrogen stream and a pressure swing adsorption tail gas stream.

### BRIEF DESCRIPTION OF THE DRAWING

In combination with the accompanying drawing and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawing can be applied to alternate processes and apparatus. Additionally, the elements and features shown in the drawing are not necessarily to scale, emphasis instead being placed upon clearly illustrating the principles of the example embodiments. Certain dimensions or positions may be exaggerated to help visually convey such principles. In the drawing, the same reference numerals used in different embodiments designate like or corresponding, but not necessarily identical, elements. In the accompanying drawing:

FIG. 1 illustrates a hydrogen separation system containing a gas separation membrane, a pressure swing adsorption unit and compressors consistent with an aspect of the present disclosure.

### DETAILED DESCRIPTION

Various illustrative embodiments described herein are directed to hydrogen separation systems and processes for the separation of cracked gases from a methane pyrolysis reaction using a hybrid membrane pressure swing adsorption process to obtain high-purity hydrogen.

As mentioned above, natural gas may be thermally cracked at high temperatures (>900° C.) and low pressures using a catalyst to form cracked gas, such as hydrogen, ethylene, C₃ to C₅ olefins, aromatics, and polynuclear aromatics. The cracked gases will need to undergo significant heat recovery and product separation. One main challenge is to recover hydrogen at high-purity. The remaining hydrocarbons must also be separated into appropriate fractions for sales into key markets. For example, high-purity ethylene is also a desirable feedstock for the polymer market, while mixed C₃ to C₅ olefins and aromatics are useful intermediates for petrochemicals.

One example of how to recover hydrogen from the cracked gases is using a hydrogen-permeable membrane to separate out the hydrogen while a series of distillation columns are used to fractionate the various hydrocarbons. Polymeric-based membranes utilize a partial-pressure driving force to permeate hydrogen across the membranes selectively over other components. A problem associated with the use of hydrogen-permeable membranes is that the hydrogen purity is often limited to the 95 to 98 mol % H₂ range, which is much lower than the desired 99.99+ mol % H₂, such as those required for fuel cells.

Another example of how to recover hydrogen from the cracked gases is using a pressure swing adsorption (PSA) process. In a PSA process, several packed beds are arranged in parallel and connected to each other, with each bed undergoing a pressure cycle. Generally, one bed will be in feed mode where pressurized gas is fed and all impurities are adsorbed onto the adsorbent, leaving high-purity, high-pressure hydrogen as the product. The other beds will be in various stages of depressurization, blowdown, or purge whereby adsorbed hydrocarbons are removed from the bed at low pressure. The process then repeats with another bed entering feed mode while the remaining beds undergo the various regeneration steps. A problem associated with the use of a PSA process is that there is a loss of pressure for the individual hydrocarbon fractions. Pressure is required for fractionation and turbo-expansion (cooling) if liquefied natural gas is not available for cooling. Another problem associated with the use of a PSA process is that the hydrocarbon tail-gas will require recompression if there are plans for further processing and recovery of the individual hydrocarbon fractions.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

The term “zone” can refer to an area including one or more equipment items and/or one or more sub-zones. Equipment items can include one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

The term “permeate” refers to a gas stream that selectively passes through a membrane. As such, the membrane is selectively permeable for the permeate.

The term “retentate” refers to a gas stream that does not pass through the membrane and thus, remains on the feed side of the membrane. As such, the membrane is not selectively permeable for the retentate.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

The term “primarily” shall be understood to mean an amount greater than 50%, e.g., 50.01% to 100%, or any range between, e.g., 51% to 95%, 75% to 90%, at least 60%, at least 70%, at least 80%, etc.

The non-limiting illustrative embodiments described herein overcome the foregoing drawbacks by providing hydrogen separation systems and processes for separation of cracked gases from a methane pyrolysis reaction using a hybrid membrane pressure swing adsorption process to obtain high-purity hydrogen.

In some embodiments, the cracked gases (i.e., a hydrogen-containing hydrocarbon gas stream) are derived from a methane pyrolysis reaction utilizing a reactor system including at least a reactor to carry out a highly endothermic light hydrocarbon catalytic cracking reaction of a light hydrocarbon feed stream using suitable catalysts under reaction conditions to produce a product effluent comprising a gas stream comprising hydrogen and unreacted light hydrocarbons, and a C₂ to C₁₀ hydrocarbon product. The particular reactor, reaction conditions and catalyst to carry out a methane pyrolysis reaction are well known to those skilled in the art in producing a product effluent comprising a gas stream comprising hydrogen and unreacted light hydrocarbons, and a C₂ to C₁₀ hydrocarbon product from a light hydrocarbon feed stream.

In some embodiments, the reactor employed to carry out the highly endothermic light hydrocarbon catalytic cracking reactions of the light hydrocarbon feed stream is not particularly limited and any suitable reactor is contemplated herein. Suitable reactors include, for example, fluidized bed reactors, sprouted bed reactors, fixed bed reactors or radial flow reactors.

The light hydrocarbon feed stream to be employed is not particularly limited and may include, for example, C₁ to C₆ or C₁ to C₄ or C₁ to C₃ or C₁ to C₂ alkanes such as methane, ethane, or natural gas either pure or in any suitable mixture. In some embodiments, the light hydrocarbon feed stream may also contain minor amounts of other ingredients including, for example, carbon dioxide, sulfur compounds such as H₂S, water, nitrogen, and mixtures thereof. In some embodiments the light hydrocarbon feed stream may also include steam, superheated steam, an inert gas such as nitrogen, or any mixture thereof. In some embodiments, the light hydrocarbon feed stream to be employed may include any suitable composition such that the resulting product includes at least hydrogen.

In some embodiments, the light hydrocarbon feed stream comprises methane or natural gas such as, for example, a light hydrocarbon feed stream comprising greater than about 80%, or greater than about 90%, or greater than about 95%, or greater than about 99% methane. As used herein, natural gas comprises methane and potentially higher alkanes, carbon dioxide, nitrogen or other gases, and/or sulfide compounds such as hydrogen sulfide, and mixtures thereof. In illustrative embodiments, the light hydrocarbon feed stream may further contain a portion of the produced products that are recycled back to the light hydrocarbon feed stream such as unreacted methane.

The produced product derived from the light hydrocarbon feed stream comprises a hydrogen-containing hydrocarbon gas stream including, for example, hydrogen and unreacted light hydrocarbons, and a C₂ to C₁₀ hydrocarbon product. In some embodiments, the hydrogen-containing hydrocarbon gas stream comprises greater than 50 mol % hydrogen. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise mixed C₃ to C₅ olefins and saturated, unsaturated, aromatic, or a mixture of such compounds. For example, the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid hydrocarbon product, a gaseous hydrocarbon product, a solid hydrocarbon product and combinations thereof depending on the particular methane conversion process.

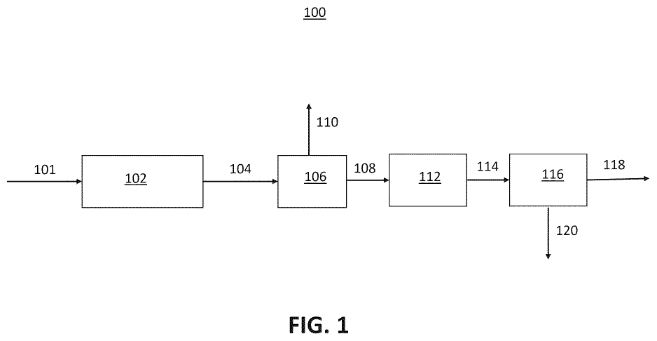

The non-limiting illustrative embodiments of the present disclosure will be specifically described below with reference to the accompanying drawing. For the purpose of clarity, some steps leading up to the production of the high-purity hydrogen from the hydrogen-containing hydrocarbon gas stream comprising hydrogen and unreacted light hydrocarbons, and a C₂ to C₁₀ hydrocarbon product as illustrated in FIG. 1 may be omitted. In other words, one or more well-known processing steps which are not illustrated but are well-known to those of ordinary skill in the art have not been included in the FIGURE. This is not intended to be interpreted as a limitation of any particular embodiment, or illustration, or scope of the claims.

### Hydrogen Separation Systems

Referring now to the drawing in more detail, FIG. 1 illustrates a hydrogen separation system 100 consistent with an aspect of the present disclosure. It is to be understood that hydrogen separation system 100 is not limited to the configuration of the embodiment shown in FIG. 1, and other configurations are contemplated herein.

In one embodiment, a hydrogen-containing hydrocarbon gas stream 101 comprising a gas stream comprising hydrogen and unreacted light hydrocarbons, and a C₂ to C₁₀ hydrocarbon product and tail gas is passed to a compressor 102 in hydrogen separation system 100. In some embodiments, hydrogen-containing hydrocarbon gas stream 101 may be pressurized to produce a compressed hydrogen-containing hydrocarbon gas stream 104 for sending to a gas separation membrane 106 as discussed below. In some embodiments, any suitable pressurization manner may be applied. Suitable compressors for compressor 102 include, for example, an air compressor such as a centrifugal, mixed-flow, axial-flow, reciprocating, rotary screw, rotary vane, scroll, diaphragm compressor, or a combination thereof. However, these are merely illustrative and any suitable compressor can be used. In some embodiments, compressed hydrogen-containing hydrocarbon gas stream 104 may have a pressure of about 20 barg to about 50 barg.

Hydrogen separation system 100 further includes gas separation membrane 106 for receiving compressed hydrogen-containing hydrocarbon gas stream 104 to provide a hydrogen-rich permeate gas stream 108 and a hydrogen-lean hydrocarbon retentate gas stream 110. Gas separation membrane 106 is hydrogen selective, in that it selectively permeates hydrogen.

Various hydrogen permeable separation membranes are known in the art. In some embodiments, gas separation membrane 106 can be configured from an inorganic material, a metallic material, an organic material, or a composite material of those materials. In some embodiments, gas separation membrane 106 can be an inorganic membrane including, for example, a zeolite membrane, a silica membrane, an alumina membrane, and composite membranes thereof. In some embodiments, gas separation membrane 106 can be an organic membrane including, for example, a polysulfone membrane, a polyimide membrane, a polyamide membrane, a cellulose acetate membrane and composite membranes thereof. In some embodiments, gas separation membrane 106 can be a metallic membrane including, for example, a palladium membrane. In some embodiments, gas separation membrane 106 is a polyimide-based membrane. Polyimide-based membranes are well known in the art and are commercially available from such sources as, for example, Air Liquide, Evonik, Ube, etc. In some embodiments, gas separation membrane 106 is a polysulfone-based membrane. Polysulfone-based membranes are well known in the art and are commercially available from such sources as, for example, Air Products. In some embodiments, gas separation membrane 106 is a rubbery membrane such as a polydimethylsiloxane. Rubbery membranes are well known in the art and are commercially available from such sources as, for example, Membrane Technology and Research, Inc. (MTR). In some embodiments, gas separation membrane 106 is a cellulose acetate membrane. Cellulose acetate membranes are well known in the art and are commercially available from such sources as, for example, UOP.

Gas separation membrane 106 may have many different shapes and sizes, such as, for example, in the form of a spiral wound membrane, a hollow fiber membrane, a tube membrane or a plate membrane. The actual selectivity for hydrogen over a C₂ to C₁₀ hydrocarbon product and unreacted light hydrocarbons can depend on the material that gas separation membrane 106 is made out of, as well as the process conditions, including the temperature and the pressure on the feed side and the permeate side, respectively.

Although one gas separation membrane 106 is shown in FIG. 1, the number of gas separation membranes is merely illustrative, and any number can be used in hydrogen separation system 100.

In some embodiments, the operating conditions of gas separation membrane 106 that are used in the process according to the present disclosure include a feed pressure of about 25 bar to about 50 bar; a permeate pressure (downstream from the membrane) of about 1 bar to about 7 bar; and a temperature of about 35° C. to about 80° C.

In some embodiments, gas separation membrane 106 is provided having a feed side and a permeate side, gas separation membrane 106 being selective for hydrogen over a C₂ to C₁₀ hydrocarbon product and unreacted light hydrocarbons. In some embodiments, compressed hydrogen-containing hydrocarbon gas stream 104 has from about 40 mol % to about 70 mol % hydrogen, from about 4 mol % to about 9 mol % C₂ to C₁₀ hydrocarbon product and unreacted methane from about 25 mol % to about 49 mol %. Compressed hydrogen-containing hydrocarbon gas stream 104 is passed across the feed side of gas separation membrane 106 resulting in hydrogen-rich permeate gas stream 108 and hydrogen-lean hydrocarbon retentate gas stream 110. In some embodiments, hydrogen-rich permeate gas stream 108 is hydrogen enriched, that is, containing greater than or equal to about 80 mol % hydrogen, e.g., from about 80 mol % to about 90 mol % hydrogen, and depleted in a C₂ to C₁₀ hydrocarbon product and unreacted light hydrocarbons such as less than 1 mol % C₂ to C₁₀ hydrocarbon product and the balance being unreacted methane. In some embodiments, hydrogen-lean hydrocarbon retentate gas stream 110 being depleted in hydrogen such as less than about 6 mol % hydrogen and enriched in a C₂ to C₁₀ hydrocarbon product such as from about 15 mol % to about 20 mol %, and the remaining balance is unreacted methane.

Hydrogen-lean hydrocarbon retentate gas stream 110, enriched in a C₂ to C₁₀ hydrocarbon product and unreacted light hydrocarbons, can be sent for further processing. For example, hydrogen-lean hydrocarbon retentate gas stream 110 may be separated into two or more constituent streams by conventional means. In non-limiting illustrative embodiments, constituent streams may include a fuel gas stream, an ethylene stream, a propylene stream, a butylene stream, an LPG stream, a naphtha stream, an olefin stream, a diesel stream, a gasoline stream, a light cycle oil LCO), a heavy cycle oil (HCO) stream, an aviation fuel stream, a cat unit bottoms (slurry/decant oil) stream, and other hydrocarbon streams.

In some aspects, a constituent stream may be further processed. In an illustrative embodiment, an olefinic constituent stream may be sent to an alkylation unit for further processing. For example, a C₃ olefin/paraffin mix stream of propane and propylene mix can be sent to and separated by a propane/propylene splitter (PP splitter) to produce pure streams of propane and propylene. The propylene can be fed to a propylene polymerization unit to produce polypropylene.

The pure propane may be fed to a propane dehydrogenation unit to make additional propylene, and then ultimately polypropylene in the propylene polymerization unit.

In addition, olefins from the constituent streams may be further separated and recovered for use in petrochemicals.

In an illustrative embodiment, C₄ and other hydrocarbon product streams, such as a heavy fraction from a fluid catalytic cracker (FCC) unit, can be sent to appropriate refinery units for upgrading into clean gasoline, diesel, or jet fuel. The gasoline from the FCC unit may be passed directly to a gasoline pool or further upgraded before being sent to a gasoline pool.

Hydrocarbon fuel products may be sold or further processed. Examples of further processing include blending, hydroprocessing, or alkylating at least a portion of the hydrocarbon fuel product. Hydrocarbon fuel products may be used as a blend stock and combined with one or more petroleum fuel products and/or renewable fuels. Petroleum-based streams include gasoline, diesel, aviation fuel, or other hydrocarbon streams obtained by refining of petroleum. Examples of fuels include ethanol, propanol, and butanol.

In some aspects, the product stream can comprise a gasoline fraction in an amount ranging from about 30 to about 60 wt. % (e.g., about 40 to about 50 wt. %), based on the total product stream composition, as measured by ASTM D2887.

In an illustrative embodiment, as may be combined with one or more of the preceding paragraphs, when one of the separated constituent streams is a heavy cycle oil (HCO), it can be subjected to coking followed by calcination to obtain needle coke.

Turning back to FIG. 1, hydrogen-rich permeate gas stream 108, which drops in pressure as it passes through gas separation membrane 106, i.e., hydrogen-rich permeate gas stream 108 has a pressure ranging from about 1 bar to about 7 bar. In some embodiments, hydrogen-rich permeate gas stream 108 is sent to a compressor 112 to increase its pressurize to produce a compressed hydrogen-rich permeate gas stream 114 for sending to a pressure swing adsorption unit 116 as discussed below. In some embodiments, any suitable pressurization manner may be applied. In some embodiments, a compressor for compressor 112 can be any of those disclosed for compressor 102. In some embodiments, compressed hydrogen-rich permeate gas stream 114 may have a pressure of about 24 bar to about 100 bar, or from about 24 bar to about 49 bar.

In some embodiments, compressed hydrogen-rich permeate gas stream 114 is passed through pressure swing adsorption unit 116 comprising one or more adsorption beds for separating hydrogen to provide a hydrogen-rich gas stream 118 and a hydrogen-lean tail gas stream 120. Pressure swing adsorption units are well known to those skilled in the art. In some embodiments, pressure swing adsorption unit 116 includes an adsorbent material comprising carbon, silica, molecular sieves, particularly zeolitic molecular sieves, metal organic frameworks, or combinations thereof. The working principle of a pressure swing adsorption unit may be understood as follows: pressure swing adsorption unit comprises a physical separation process that allows small molecules, e.g., hydrogen, to pass through while trapping larger molecules (the adsorbate). Desorption and regeneration of the adsorbent are accomplished by reducing the adsorptive capacity of the adsorbent by lowering the pressure and purging the adsorbent with a portion of the hydrogen-rich gas. A pressure swing cycle can consist of adsorption; depressurization; purge at low pressure; and repressurization. This cycle may be carried out using two or more beds of an adsorbent in parallel that are capable of selectively adsorbing impurities, such as methane, from a hydrogen-rich gas. The most efficient systems operate with more than two beds with one or more of the beds undergoing regeneration while the others are adsorbing. The hydrogen-rich gas is used as much as possible to purge and repressure other beds.

Although one pressure swing adsorption unit 116 is shown in FIG. 1, the number of pressure swing adsorption units is merely illustrative, and any number can be used in hydrogen separation system 100.

The purified hydrogen gas product, i.e., hydrogen-rich gas stream 118, is taken from pressure swing adsorption unit 116. In some embodiments, hydrogen-rich gas stream 118 includes high-purity hydrogen and containing greater than about 98 mol % hydrogen, or greater than about 99 mol % hydrogen, or greater than 99.9 mol % hydrogen, and may be used for any purpose for which high-purity hydrogen is needed.

In some embodiments, hydrogen-rich gas stream 118 will typically be at substantially the same pressure as compressed hydrogen-rich permeate gas stream 114 entering pressure swing adsorption unit 116, since there is usually very little pressure drop through pressure swing adsorption unit 116 for the hydrogen.

In one embodiment, hydrogen-lean tail gas stream 120 is rejected tail gas containing unreacted methane and unrecovered hydrogen.

The following illustrative example is intended to be non-limiting.

### Example 1

The improvement of the energy efficiency obtained by hydrogen separation system containing a gas separation membrane, a pressure swing adsorption unit and compressors, was evaluated via process simulations. Example 1 is illustrative of the method and system of FIG. 1, Comparative Example A is illustrative of the method and system employing only a gas separation membrane, and Comparative Example B is illustrative of the method and system employing only a pressure swing adsorption unit. The key performance indicators are summarized in Table 1.

TABLE 1

| | | Comp. | Comp. |
|---|---|---|---|
| | Ex. 1 | Ex. A | Ex. B |
| Natural Gas as Feedstock (MMSCFD) | 105 | 75 | 78 |
| Natural Gas as Fuel (MMSCFD) | 0 | 18 | 18 |
| Power Import (MW) | 15 | 24 | 23 |
| Gross H₂ Production (MMSCFD) | 110 | 115 | 109 |
| Net H₂ Production (MMSCFD) | 100 | 105 | 100 |
| LNG Regas Capacity (MMSCFD) | 275 | 250 | 250 |
| H₂ Product Purity (mol %) | 99.99+ | 95 | 99.99+ |
| Coke Formation on Catalyst | 337 | 312 | 280 |
| Ethylene (97+ wt. %) Production | 719 | 614 | 628 |
| (tonne/day) | | | |
| Mixed C3/C4/C5 Olefin Production | 84 | 73 | 70 |
| (tonne/day) | | | |
| Aromatics Production (tonne/day) | 342 | 283 | 288 |
| Direct CO₂ Emissions (tonne/day) | 2280 | 2105 | 2378 |

According to an aspect of the present disclosure, a process for producing high-purity hydrogen comprises:
compressing a hydrogen-containing hydrocarbon gas stream derived from catalytically cracking a light hydrocarbon feedstock in the presence of a catalyst in a reactor, thereby producing a compressed hydrogen-containing hydrocarbon gas stream,
passing the compressed hydrogen-containing hydrocarbon gas stream through a gas separation membrane, thereby producing a hydrogen-lean hydrocarbon retentate gas stream and a hydrogen-rich permeate gas stream,
compressing the hydrogen-rich permeate stream, thereby producing a compressed hydrogen-rich permeate gas stream, and
introducing the compressed hydrogen-rich permeate gas stream into a pressure swing adsorption unit, thereby producing a high-purity hydrogen stream and a pressure swing adsorption tail gas stream.

In one or more additional illustrative embodiments, as may be combined with the preceding paragraphs, the high-purity hydrogen stream comprises greater than 95 mol % hydrogen.

In one or more additional illustrative embodiments, as may be combined with the preceding paragraphs, the high-purity hydrogen stream comprises greater than 99 mol % hydrogen.

In one or more additional illustrative embodiments, as may be combined with the preceding paragraphs, the high-purity hydrogen stream comprises greater than 99.9 mol % hydrogen.

In one or more additional illustrative embodiments, as may be combined with the preceding paragraphs, the compressed hydrogen-containing hydrocarbon gas stream has a pressure of from about 20 barg to about 50 barg.

In one or more additional illustrative embodiments, as may be combined with the preceding paragraphs, the hydrogen-rich permeate gas stream has a pressure of from about 1 bar to about 7 bar.

In one or more additional illustrative embodiments, as may be combined with the preceding paragraphs, the hydrogen-containing hydrocarbon gas stream is derived from a methane pyrolysis reaction.

In one or more additional illustrative embodiments, as may be combined with the preceding paragraphs, the hydrogen-rich permeate gas stream has from about 80 mol % to about 90 mol % hydrogen.

In one or more additional illustrative embodiments, as may be combined with the preceding paragraphs, the gas separation membrane is one or more of a polyimide gas separation membrane and a polyamide gas separation membrane.

In one or more additional illustrative embodiments, as may be combined with the preceding paragraphs, the compressed hydrogen-rich permeate gas stream has a pressure of from about 24 bar to about 49 bar.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 95 mol % hydrogen.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 99 mol % hydrogen.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 99.99 mol % hydrogen.

In one or more additional illustrative embodiments, as may be combined with the preceding paragraphs, the process further comprises passing the pressure swing adsorption tail gas stream to a reactor, and burning the pressure swing adsorption tail gas stream to generate heat for the reactor.

According to another aspect of the present disclosure, a process for producing high-purity hydrogen comprises:
passing a compressed hydrogen-containing hydrocarbon gas stream having a first pressure through a gas separation membrane, thereby producing a hydrogen-lean hydrocarbon retentate gas stream and a hydrogen-rich permeate gas stream having a second pressure less than the first pressure;
compressing the hydrogen-rich permeate stream, thereby producing a compressed hydrogen-rich permeate gas stream having a third pressure greater than the second pressure; and
introducing the compressed hydrogen-rich permeate gas stream into a pressure swing adsorption unit, thereby producing a high-purity hydrogen stream and a pressure swing adsorption tail gas stream.

In one or more additional illustrative embodiments, as may be combined with the preceding paragraphs, the first pressure is from about 20 barg to about 50 barg and the second pressure is from about 1 bar to about 7 bar.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 95 mol % hydrogen.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 99 mol % hydrogen.

In one or more additional illustrative embodiments, as may be combined with the preceding paragraphs, the hydrogen-rich permeate gas stream has from about 80 mol % to about 90 mol % hydrogen, and the high-purity hydrogen stream comprises greater than 99.99 mol % hydrogen.

In one or more additional illustrative embodiments, as may be combined with the preceding paragraphs, the process further comprises passing the pressure swing adsorption tail gas stream to a reactor, and burning the pressure swing adsorption tail gas stream to generate heat for the reactor.

According to yet another aspect of the present disclosure, a system comprises:
a first compressor configured to compress a hydrogen-containing hydrocarbon gas stream derived from catalytically cracking a light hydrocarbon feedstock in the presence of a catalyst in a reactor, thereby producing a compressed hydrogen-containing hydrocarbon gas stream,
a gas separation membrane configured to separate the compressed hydrogen-containing hydrocarbon gas stream, thereby producing a hydrogen-lean hydrocarbon retentate gas stream and a hydrogen-rich permeate gas stream,
a second compressor configured to compress the hydrogen-rich permeate stream, thereby producing a compressed hydrogen-rich permeate gas stream, and
a pressure swing adsorption unit configured to separate the compressed hydrogen-rich permeate gas stream into, thereby producing a high-purity hydrogen stream and a pressure swing adsorption tail gas stream.

In one or more additional illustrative embodiments, as may be combined with the preceding paragraphs, the system further comprises a reactor configured to carry out a methane pyrolysis reaction of a light hydrocarbon feedstock in the presence of a catalyst, thereby producing the hydrogen-containing hydrocarbon gas stream.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for producing high-purity hydrogen, comprising:
compressing a hydrogen-containing hydrocarbon gas stream derived from catalytically cracking a light hydrocarbon feedstock in the presence of a catalyst in a reactor, thereby producing a compressed hydrogen-containing hydrocarbon gas stream;
passing the compressed hydrogen-containing hydrocarbon gas stream through a gas separation membrane, thereby producing a hydrogen-lean hydrocarbon retentate gas stream and a hydrogen-rich permeate gas stream;
compressing the hydrogen-rich permeate stream, thereby producing a compressed hydrogen-rich permeate gas stream; and
introducing the compressed hydrogen-rich permeate gas stream into a pressure swing adsorption unit, thereby producing a high-purity hydrogen stream and a pressure swing adsorption tail gas stream.

2. The process according to claim 1, wherein the high-purity hydrogen stream comprises greater than 99 mol % hydrogen.

3. The process according to claim 1, wherein the high-purity hydrogen stream comprises greater than 99.9 mol % hydrogen.

4. The process according to claim 1, wherein the compressed hydrogen-containing hydrocarbon gas stream has a pressure of from about 20 barg to about 50 barg.

5. The process according to claim 4, wherein the hydrogen-rich permeate gas stream has a pressure of from about 1 bar to about 7 bar.

6. The process according to claim 1, wherein the hydrogen-containing hydrocarbon gas stream is derived from a methane pyrolysis reaction.

7. The process according to claim 1, wherein the hydrogen-rich permeate gas stream has from about 80 mol % to about 90 mol % hydrogen.

8. The process according to claim 1, wherein the gas separation membrane is one or more of a polyimide gas separation membrane and a polyamide gas separation membrane.

9. The process according to claim 1, wherein the compressed hydrogen-rich permeate gas stream has a pressure of from about 24 bar to about 49 bar.

10. The process according to claim 1, wherein the hydrogen-rich permeate gas stream has from about 80 mol % to about 90 mol % hydrogen, and the high-purity hydrogen stream comprises greater than 99 mol % hydrogen.

11. The process according to claim 1, wherein the hydrogen-rich permeate gas stream has from about 80 mol % to about 90 mol % hydrogen, and the high-purity hydrogen stream comprises greater than 99.9 mol % hydrogen.

12. The process according to claim 1, wherein the compressed hydrogen-containing hydrocarbon gas stream has from about 40 mol % to about 70 mol %, the hydrogen-rich permeate gas stream has from about 80 mol % to about 90 mol % hydrogen, and the high-purity hydrogen stream comprises greater than 99.9 mol % hydrogen.

13. The process according to claim 1, further comprising:
passing the pressure swing adsorption tail gas stream to a reactor; and
burning the pressure swing adsorption tail gas stream to generate heat for the reactor.

14. A process for producing high-purity hydrogen, comprising:
passing a compressed hydrogen-containing hydrocarbon gas stream having a first pressure through a gas separation membrane, thereby producing a hydrogen-lean hydrocarbon retentate gas stream and a hydrogen-rich permeate gas stream having a second pressure less than the first pressure;
compressing the hydrogen-rich permeate stream, thereby producing a compressed hydrogen-rich permeate gas stream having a third pressure greater than the second pressure; and
introducing the compressed hydrogen-rich permeate gas stream into a pressure swing adsorption unit, thereby producing a high-purity hydrogen stream and a pressure swing adsorption tail gas stream.

15. The process according to claim 14, wherein the first pressure is from about 20 barg to about 50 barg and the second pressure of from about 1 bar to about 7 bar.

16. The process according to claim 14, wherein the hydrogen-rich permeate gas stream has from about 80 mol % to about 90 mol % hydrogen, and the high-purity hydrogen stream comprises greater than 99 mol % hydrogen.

17. The process according to claim 14, wherein the hydrogen-rich permeate gas stream has from about 80 mol % to about 90 mol % hydrogen, and the high-purity hydrogen stream comprises greater than 99.9 mol % hydrogen.

18. The process according to claim 14, wherein the compressed hydrogen-containing hydrocarbon gas stream has from about 40 mol % to about 70 mol %, the hydrogen-rich permeate gas stream has from about 80 mol % to about 90 mol % hydrogen, and the high-purity hydrogen stream comprises greater than 99.99 mol % hydrogen.

19. The process according to claim 14, wherein the gas separation membrane is one or more of a polyimide gas separation membrane and a polyamide gas separation membrane.

20. The process according to claim 14, further comprising:
passing the pressure swing adsorption tail gas stream to a reactor; and
burning the pressure swing adsorption tail gas stream to generate heat for the reactor.
